(19) United States
(12) Patent Application Publication
(10) Pub. No.: US 2025/0220774 A1
(43) Pub. Date: Jul. 3, 2025

(54) DATA CHANNEL SWITCHING FOR MULTI-SIM DEVICES

(71) Applicant: T-MOBILE INNOVATIONS LLC, Overland Park, KS (US)

(72) Inventors: Jagannadha Anudeep Varma DATLA, Kent, WA (US); Harikishore Allu BALAN, Lynnwood, WA (US); Mallika Sudip DESHPANDE, Sammamish, WA (US)

(21) Appl. No.: 18/403,252

(22) Filed: Jan. 3, 2024

(51) Int. Cl. H04W 76/45; H04W 8/18; H04W 88/06

(52) U.S. Cl. CPC H04W 76/45; H04W 8/183; H04W 88/06

(57) ABSTRACT

Systems and methods are provided for automatic data channel switching on a failure for multi-SIM devices. Multi-SIM devices can include multiple SIM profiles associated with different telecommunications network carriers. When a data channel fails, features that require data are lost. Multi-SIM devices can include a first SIM profile that enables push-to-talk (PTT) functionality while a second SIM profile does not. Upon determining that the data channel associated with the first SIM profile fails, the second SIM profile can be utilized to attach to a different data channel associated with the second SIM profile such that data is provided to a device via the second SIM profile but the first SIM profile is still utilized to enable PTT functionality.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

In aspects set forth herein, systems and methods are provided for automatic data channel switching. More particularly, in aspects set forth herein, systems and methods enable multi-SIM (subscriber identity module) devices to utilize multiple profiles simultaneously to switch between data channels of different carriers in order to provide data via one SIM profile and provide feature functionality via a different SIM profile not being used for the data channel connection.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed, in accordance with aspects herein;

FIG. 2 depicts a diagram of an exemplary call flow in which implementations of the present disclosure may be employed, in accordance with aspects herein;

FIG. 3 depicts a diagram of an exemplary call flow in which implementations of the present disclosure may be employed, in accordance with aspects herein;

FIG. 4 depicts a flow diagram of a method for data channel switching, in accordance with aspects herein;

FIG. 5 depicts a flow diagram of a method for data channel switching, in accordance with aspects herein; and

FIG. 6 depicts a diagram of an exemplary computing environment suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
APN Access Point Name
CD-ROM Compact Disk Read Only Memory
CDMA Code Division Multiple Access
eNodeB Evolved Node B
GIS Geographic/Geographical/Geospatial Information System
gNodeB Next Generation Node B
GPRS General Packet Radio Service
GSM Global System for Mobile communications
iDEN Integrated Digital Enhanced Network
DVD Digital Versatile Discs
EEPROM Electrically Erasable Programmable Read Only Memory
LED Light Emitting Diode
LTE Long Term Evolution
MIMO Multiple Input Multiple Output
MD Mobile Device
PC Personal Computer
PCS Personal Communications Service
PDA Personal Digital Assistant
PTT Push-to-Talk
RAM Random Access Memory
RET Remote Electrical Tilt
RF Radio-Frequency
RFI Radio-Frequency Interference
R/N Relay Node
ROM Read Only Memory
SINR Transmission-to-Interference-Plus-Noise Ratio
SIM Subscriber Identity Module
SNR Transmission-to-noise ratio
SON Self-Organizing Networks
TDMA Time Division Multiple Access
TXRU Transceiver (or Transceiver Unit)
UE User Equipment

Further, various technical terms are used throughout this description. An illustrative resource that fleshes out various aspects of these terms can be found in Newton's Telecom Dictionary, 32d Edition (2022).

As used herein, the term “node” is used to refer to network access technology for the provision of wireless telecommunication services from a base station to one or more electronic devices, such as an eNodeB, gNodeB, etc.

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions-including data structures and program modules-in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a traditional telecommunications network employs a plurality of base stations (i.e., cell sites, cell towers) to provide network coverage. The base stations are employed to broadcast and transmit transmissions to user devices of the telecommunications network. An access point may be considered to be a portion of a base station that may comprise an antenna, a radio, and/or a controller.

As employed herein, a UE (also referenced herein as a user device) or WCD can include any device employed by an end-user to communicate with a wireless telecommunications network. A UE can include a mobile device, a mobile broadband adapter, or any other communications device employed to communicate with the wireless telecommunications network. A UE, as one of ordinary skill in the art may appreciate, generally includes one or more antenna coupled to a radio for exchanging (e.g., transmitting and receiving) transmissions with a nearby base station.

The present disclosure is directed to automatic channel switching for multi-SIM devices upon a data channel failure. Currently, when push-to-talk (PTT) service is subscribed on a subscriber identity module (SIM) profile and the data channel for that SIM profile is dropped, a UE has no option to select a different data channel of a different SIM profile to continue PTT services.

Accordingly, a first aspect of the present disclosure is directed to a system for data channel switching. The system comprises one or more processors and one or more computer-readable media storing computer-usable instructions that, when executed by the one or more processors, cause the one or more processors to: connect a device to a first data channel via a first subscriber identity module (SIM) profile, wherein the first SIM profile enables push-to-talk (PTT) capabilities; identify that the first data channel has failed; communicate a request to re-authenticate with a second data channel utilizing a second SIM profile; attach to the second data channel utilizing the second SIM profile; and activate PTT capabilities utilizing the first SIM profile on the second data channel associated with the second SIM profile.

A second aspect of the present disclosure is directed to a method for data channel switching. The method comprises: connecting a device to a first data channel via a first subscriber identity module (SIM) profile, wherein the first SIM profile enables push-to-talk (PTT) capabilities; identifying that the first data channel has failed; communicating a request to re-authenticate with a second data channel utilizing a second SIM profile; attaching to the second data channel utilizing the second SIM profile; and activating PTT capabilities utilizing the first SIM profile on the second data channel associated with the second SIM profile.

Another aspect of the present disclosure is directed to a method for data channel switching. The method comprises: connecting a device to a first data channel via a first subscriber identity module (SIM) profile, wherein the first SIM profile enables push-to-talk (PTT) capabilities; identifying that the first data channel has failed; communicating a request to re-authenticate with a second data channel utilizing a second SIM profile; attaching to the second data channel utilizing the second SIM profile to establish a second data channel data connection; activating PTT capabilities utilizing the first SIM profile on the second data channel associated with the second SIM profile; identifying that the first data channel is available; and switching from the second data channel to the first data channel, wherein a first data channel data connection and PTT capabilities are enabled utilizing the first SIM profile.

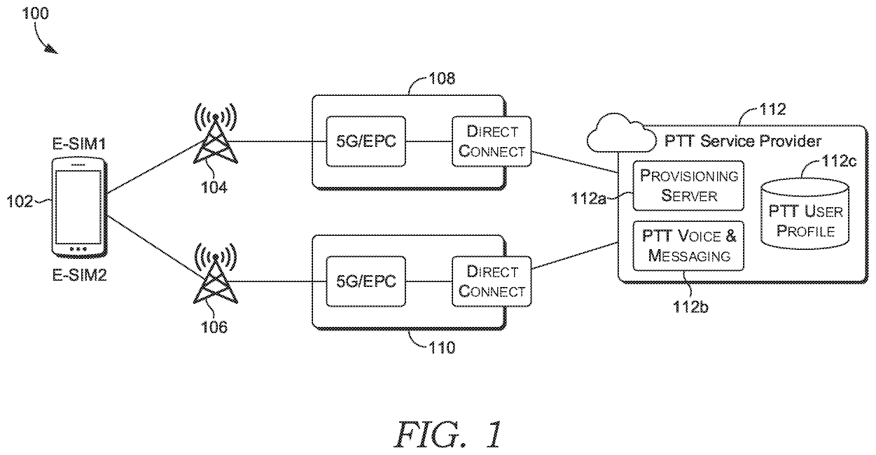

Turning to FIG. 1, a network environment suitable for use in implementing embodiments of the present disclosure is provided. Such a network environment is illustrated and designated generally as network environment 100. Network environment 100 is but one example of a suitable network environment and is not intended to suggest any limitation as to the scope of use or functionality of the disclosure. Neither should the network environment 100 be interpreted as having any dependency or requirement relating to any one or combination of components illustrated.

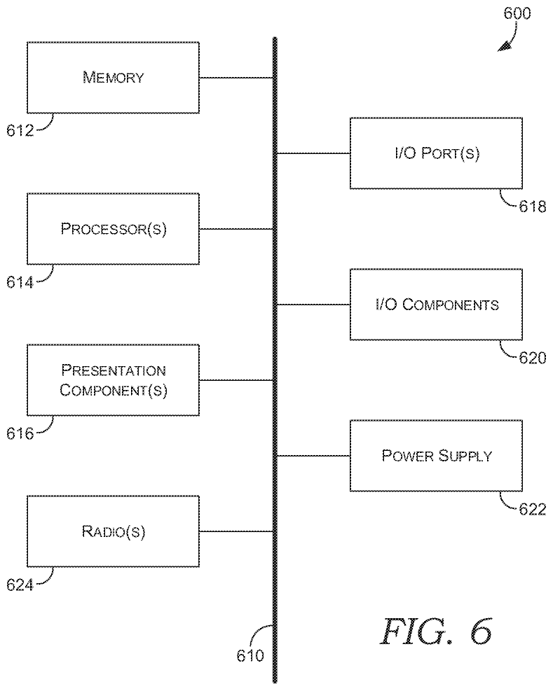

A network cell may comprise a base station to facilitate wireless communication between a communications device within the network cell, such as communications device 600 described with respect to FIG. 6, and a network. As shown in FIG. 1, communications device may be UE 102. In the network environment 100, UE 102 may communicate with other devices, such as mobile devices, servers, etc. The UE 102 may take on a variety of forms, such as a personal computer, a laptop computer, a tablet, a netbook, a mobile phone, a Smart phone, a personal digital assistant, or any other device capable of communicating with other devices. For example, the UE 102 may take on any form such as, for example, a mobile device or any other computing device capable of wirelessly communication with the other devices using a network. Makers of illustrative devices include, for example, Research in Motion, Creative Technologies Corp., Samsung, Apple Computer, and the like. A device can include, for example, a display(s), a power source(s) (e.g., a battery), a data store(s), a speaker(s), memory, a buffer(s), and the like. In embodiments, UE 102 comprises a wireless or mobile device with which a wireless telecommunication network(s) can be utilized for communication (e.g., voice and/or data communication). In this regard, the UE 102 can be any mobile computing device that communicates by way of, for example, a 5G network.

The UE 102 may utilize a network to communicate with other computing devices (e.g., mobile device(s), a server(s), a personal computer(s), etc.). In embodiments, the network is a telecommunications network, or a portion thereof. A telecommunications network might include an array of devices or components, some of which are not shown so as to not obscure more relevant aspects of the invention. Components such as terminals, links, and nodes (as well as other components) may provide connectivity in some embodiments. The network may include multiple networks. The network may be part of a telecommunications network that connects subscribers to their immediate service provider. In embodiments, the network is associated with a telecommunications provider that provides services to user devices, such as UE 102. For example, the network may provide voice services to user devices or corresponding users that are registered or subscribed to utilize the services provided by a telecommunications provider.

As shown in FIG. 1, the UE 102 can be a multi-SIM device. UE 102 is illustrated as having two electronic SIM profiles (shown as e-SIM1 and e-SIM2) but either of the illustrated e-SIM profiles could be a physical SIM input such that UE 102 has an e-SIM1 and a physical SIM2. Each SIM profile can be associated with a telecommunications network carrier. Multi-SIM devices can have SIM profiles that are associated with different telecommunications network carriers, such that a first SIM profile is associated with a first carrier and a second SIM profile is associated with a second carrier (different from the first carrier). As shown in FIG. 1, e-SIM1 is meant to be associated with a first network carrier through tower 104 and eSIM2 is meant to be associated with a second network carrier through tower 106. Each of manager 108 and manager 110 are depicting a controller associated with a respective tower that facilitates communication between tower 104 and tower 106 with a PTT service provider 112. The managers 108 and 110 condense the entire telecommunications network connection and functions thereof. Thus, normal network functions such as authentication, attachment, etc., are performed at the network-level and meant to be included in managers 108 and 110 associated with each respective tower.

The PTT service provider 112 may be associated with a carrier of a telecommunications network, or may be separate. The PTT service provider 112 includes a PTT provisioning server 112a, a PTT voice and messaging server 112b, and a PTT user profile 112c. The PTT service provider 112 manages all PTT services for UEs. Thus, the PTT service provider 112 is in control of authentication of a UE to launch/use PTT services, providing PTT services to UEs, and the like. The PTT user profile 112c is maintained with active PTT subscribers and their relevant data (e.g., SIM profiles, device information, etc.) such that their PTT service is available upon attachment to a network and provided via that PTT voice and messaging server 112b. Authentication at the PTT service provider 112 is typically performed during a power cycle of a UE and, otherwise, remains idle in the background.

Imagine an example where UE 102 is connected to tower 104 via e-SIM1 profile. The e-SIM1 profile subscribes to PTT services. The e-SIM1 profile is communicated to the tower 104, which is associated with a first carrier. Thus, the e-SIM1 profile is associated with the first carrier. Upon an initial attach to the network, the e-SIM1 profile is communicated to the PTT service provider 112 via the first carrier/network 104. Data channels are provided by the first carrier using the e-SIM1 profile and PTT services are provided by the PTT provider 112 upon authentication of the e-SIM1 profile and the subscription of the e-SIM1 profile to PTT services. In the event that the data channel fails, a data connection with the UE 102 would be lost. The PTT service cannot function without a functional data bearer/data channel. Thus, the PTT service would be unavailable. In current systems, if a device tried to switch between SIM profiles, a SIM swap would be detected and the user would be kicked out of services (e.g., the user would be logged out of the PTT service). The present system seeks to avoid this disruption in service by providing a mechanism by which the UE 102 can switch between SIM profiles without loss of service. More particularly, the present system allows the UE 102 to utilize a different SIM profile (associated with a different carrier than a first SIM profile/primary SIM profile) as a data bearer while still utilizing the primary/first SIM profile to access PTT services.

Returning to FIG. 1, this can be illustrated by envisioning that the data bearer of e-SIM1 has failed and, as such, the PTT services for e-SIM1 are unavailable. In that case, the e-SIM2 profile can be utilized to access a data bearer (tower 106) to provide a data channel connection to the UE 102. A re-authentication request can be communicated from the UE 102 to the tower 106 (and the manager 110) associated with the network carrier associated with e-SIM2. The re-authentication request comprises the e-SIM1 profile and the e-SIM2 profile. The e-SIM2 profile is needed to access the data channel of its respective carrier (as e-SIM1 is associated with a different carrier) and the e-SIM1 profile is needed as the PTT services are enabled for the e-SIM1 profile. Thus, the manager 110 grants access to the network data channels for UE 102 utilizing the e-SIM2 profile. With an operable data channel, PTT services can now be functional but e-SIM2 is not configured for PTT services. Thus, the PTT service provider 112 utilizes e-SIM1 profile to authenticate UE 102 for PTT services.

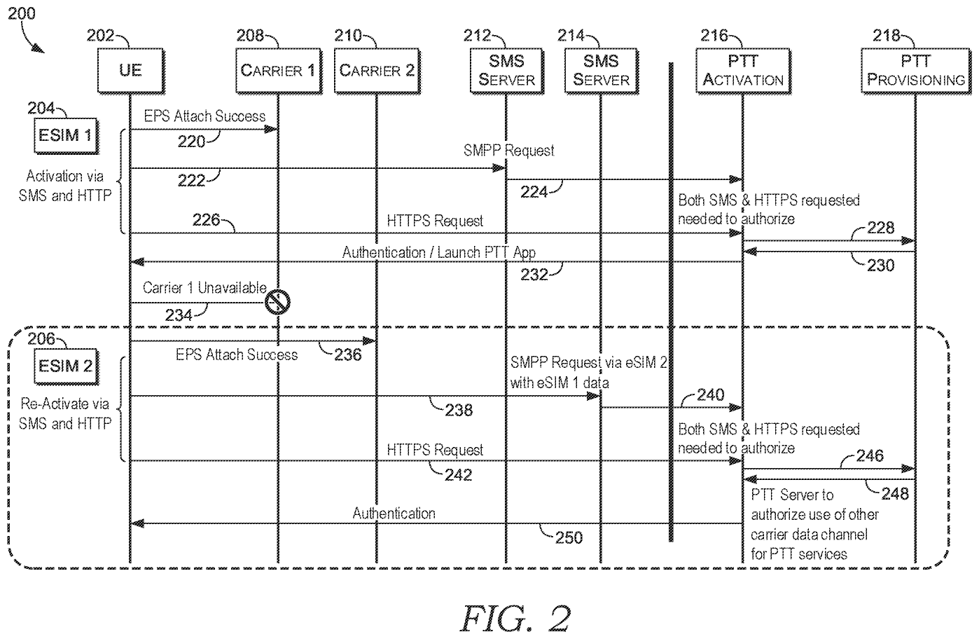

An exemplary call flow 200 is illustrated in FIG. 2. As shown, a UE 202 is a multi-SIM device comprising e-SIM1 204 and e-SIM2 206. In this illustration, e-SIM1 204 is associated with carrier 1 208 while e-SIM2 is associated with carrier 2 210. Additionally, each carrier is associated with a respective SMS server; e-SIM1 204 is associated with SMS server 212 and e-SIM2 is associated with SMS server 214. Finally, a PTT service provider is associated with a PTT activation server 216 and a PTT provisioning server 218. Initially, at step 220, the UE 202 attaches to the network via carrier 1 208. As is custom, an SMPP request is communicated from the UE 202 to the SMS server 212 at step 222. A PTT request is communicated at step 224 for the e-SIM1 profile 204 and an HTTPS request is communicated from the UE 202 at step 232. Both SMS and HTTPS requests are needed to authorize PTT services. The PTT activation server 216 communicates with the PTT provisioning server 218 to verify the UE 202 and e-SIM1 profile 204 should have access to PTT services via step 228. Once confirmed, the PTT provisioning server 218 communicates an activation verification at step 230. A PTT application on UE 202 is then launched at step 232.

At step 234, carrier 1 208 becomes unavailable. The present invention provides utilization of the e-SIM2 profile 206 to maintain continuity of PTT services even with a data channel failure. Re-activation via SMS and HTTPS is initiated at step 236 with carrier 2 210 (different from carrier 1 208). The SMPP request is communicated from the UE 202 to the SMS server 214 (associated with carrier 2 210). The SMPP request comprises both e-SIM2 profile 206 data and e-SIM1 profile 204 data. The SMS request data is communicated from the SMS server 214 to the PTT activation server 216 at step 240 as well as the HTTPS request at step 242. The PTT activation server 216 communicates the SMS and HTTPS request data to the PTT provisioning server 218 at step 246. The PTT provisioning server 218 identifies that e-SIM1 204 is authorized for PTT services and confirms the authorization at step 248 with an authorization to use a data channel of a carrier different than the carrier associated with the approved e-SIM profile. Specifically, the e-SIM1 profile 204, along with carrier 1 208, is authorized for PTT access, not carrier 2 210. However, the requests that include both e-SIM profiles are provisioned such that the e-SIM1 profile 204 is authorized along with a different carrier (carrier 2 210) associated with a dual SIM profile of UE 202. Authentication is communicated at step 250 and the PTT services remain available to the UE 202.

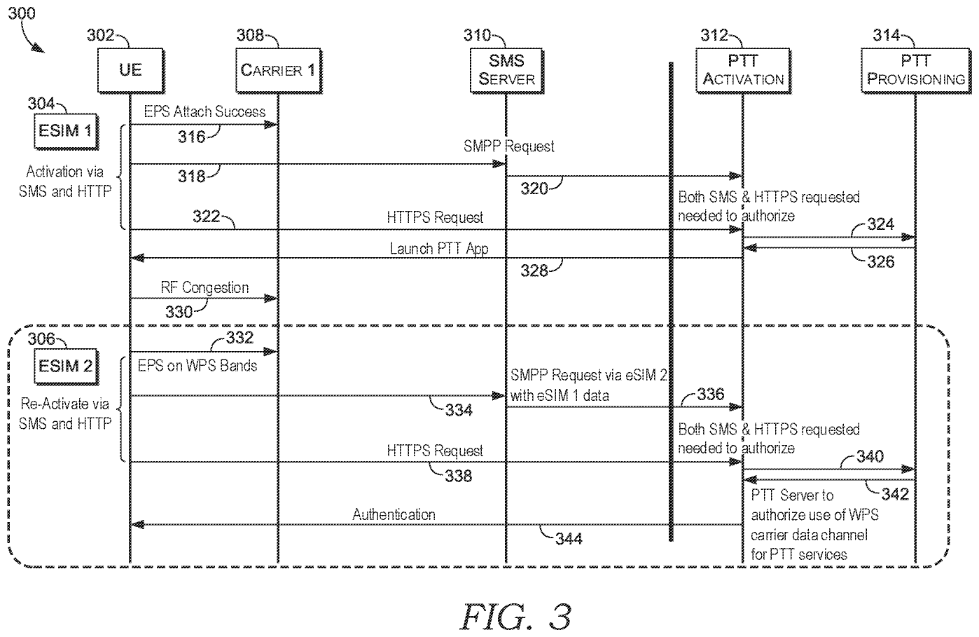

FIG. 3 provides another exemplary call flow 300 but for a different aspect of RF congestion rather than data channel failure. As in FIG. 2, the call flow includes a dual-SIM UE 302, a carrier 1 308, a SMS server 310, a PTT activation server 312, and a PTT provisioning server 314. The UE 302 is associated with e-SIM1 profile 304 and e-SIM2 profile 306. In this call flow 300, both are associated with carrier 1 308.

As with FIG. 2, the flow starts with attachment success of the UE 302 to the network via carrier 1 308 at step 316. In order to configure PTT services, an SMPP request is communicated at step 318 (from the UE 302 to the SMS server 310). The SMS request data is then forwarded to the PTT activation server 312 at step 320. A HTTPS request is communicated from the UE 302 to the PTT activation server at step 322. The HTTPS and SMS request data is communicated to the PTT provisioning server 314 at step 324. Once confirmed that the e-SIM1 profile 304 has signed up for PTT services, a confirmation is communicated at step 326. The PTT application is then launched on the UE 302 at step 328.

At step 330, it is identified that the data channel is experiencing RF congestion. This may be caused by a national emergency in a location, a highly populated event (e.g., concert, sporting event, etc.), and the like. In the instance of RF congestion, attachment to the network via the same carrier (carrier 1 308) can be achieved on a second SIM profile (i.e., e-SIM2 profile 306) when the second SIM profile is associated with wireless priority service (WPS). Networks typically allocate a percentage of the network bands to WPS. WPS is a federal program that authorizes telecommunications network providers to prioritize certain calls over the network. Exemplary prioritized categories may include federal, state, and local police departments, fire departments, 911 services, essential healthcare providers, and the like. While other users may experience RF congestion and, as a result, very low latency or poor service, WPS-enabled SIM profiles can still connect to the network and maintain PTT services on a designated data channel.

Continuing on, a WPS attachment request is communicated at step 332 for WPS-enabled e-SIM2 profile 306. SMS data is communicated from the UE 302 at step 334 to the SMS server 310 and forwarded on to the PTT activation server 312 at step 336. Both the WPS-enabled e-SIM2 profile 306 data and the PTT-enabled e-SIM1 profile 304 data are included in step 336. HTTPS data is also communicated at step 338. The data is forwarded from the PTT activation server 312 to the PTT provisioning server 314 at step 340. The PTT provisioning server 314 determines that a WPS data channel can be used for PTT services at step 342 and authorizes the connection. Authentication is communicated at step 344 and PTT services are maintained on a WPS data channel.

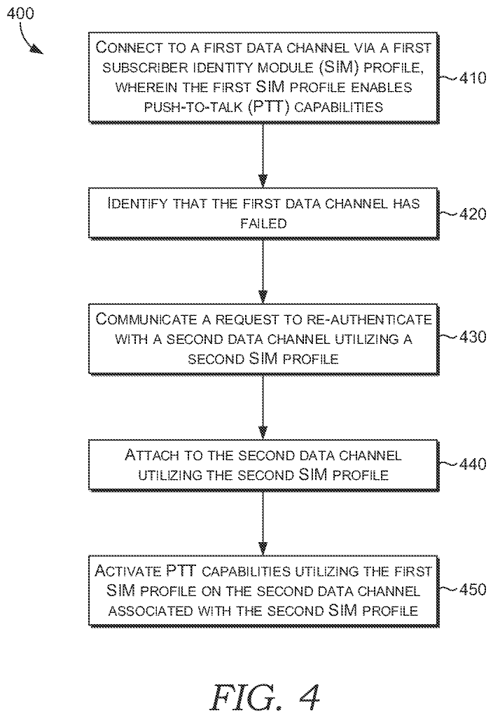

Referring to FIG. 4, a flow diagram 400 is provided illustrating a flow to automatically switch data channels using multiple SIM profiles associated with different carriers. Initially, at block 410, a device connects to a first data channel via a first subscriber identity module (SIM) profile, wherein the first SIM profile enables push-to-talk (PTT) capabilities. At block 420, it is identified that the first data channel has failed. A request is communicated to re-authenticate with a second data channel utilizing a second SIM profile at block 430. At block 440, the device attaches to the second data channel utilizing the second SIM profile. At block 450, PTT capabilities are activated utilizing the first SIM profile on the second data channel associated with the second SIM profile.

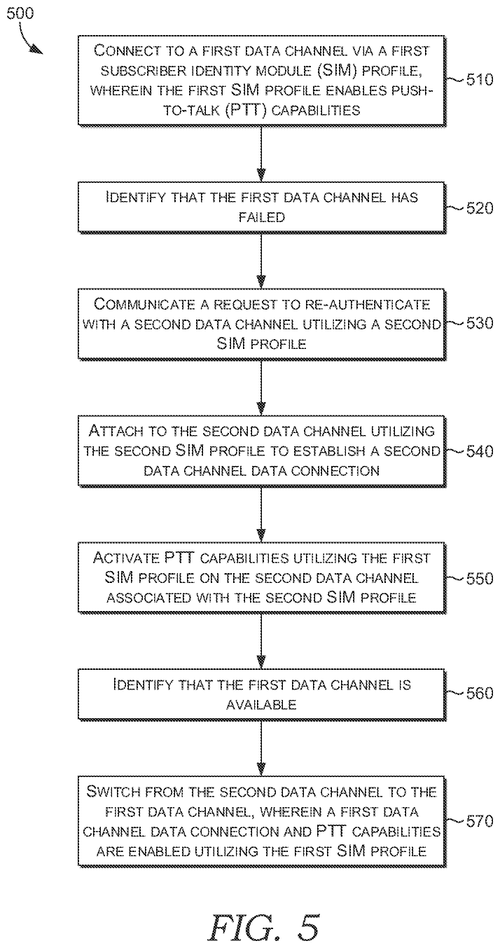

In FIG. 5, a flow diagram 500 is provided depicting a flow to automatically switch data channels using multiple SIM profiles associated with different carriers. Initially, at block 510, a device is connected to a first data channel via a first subscriber identity module (SIM) profile, wherein the first SIM profile enables push-to-talk (PTT) capabilities. At block 520, it is identified that the first data channel has failed. A request to re-authenticate with a second data channel utilizing a second SIM profile is communicated at block 530. At block 540, the device attaches to the second data channel utilizing the second SIM profile to establish a second data channel data connection. PTT capabilities are activated utilizing the first SIM profile on the second data channel associated with the second SIM profile at block 550. At block 560, it is identified that the first data channel is available. Availability of a channel can be determined using periodic health checks for the channel. The periodic health check(s) can continue for a predetermined period of time (e.g., one hour) once the data channel is available to determine that the connection is stable. Stability, as used herein, refers generally to a connection without any interruptions for a predetermined period of time (e.g., one hour) once the channel is regained. In other words, once a connection is available, the periodic health checks continue for an extended period of time to define that the connection is stable. If a token on the second data channel connection expires during the extended monitoring, service would be switched back to the first data channel irrespective of the stability instead of re-authenticating on the second data channel. At block 570, the device switches from the second data channel to the first data channel, wherein a first data channel data connection and PTT capabilities are enabled utilizing the first SIM profile. As stated above, this can happen when the token/authentication of the second data channel expires or upon determining that the first data channel is available.

Referring to FIG. 6, a block diagram of an exemplary computing device 600 suitable for use in implementations of the technology described herein is provided. In particular, the exemplary computer environment is shown and designated generally as computing device 600. Computing device 600 is but one example of a suitable computing environment and is not intended to suggest any limitation as to the scope of use or functionality of the invention. Neither should computing device 600 be interpreted as having any dependency or requirement relating to any one or combination of components illustrated. It should be noted that although some components in FIG. 6 are shown in the singular, they may be plural. For example, the computing device 600 might include multiple processors or multiple radios. In aspects, the computing device 600 may be a UE/WCD, or other user device, capable of two-way wireless communications with an access point. Some non-limiting examples of the computing device 600 include a cell phone, tablet, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 6, computing device 600 includes a bus 610 that directly or indirectly couples various components together, including memory 612, processor(s) 614, presentation component(s) 616 (if applicable), radio(s) 624, input/output (I/O) port(s) 618, input/output (I/O) component(s) 620, and power supply(s) 622. Although the components of FIG. 6 are shown with lines for the sake of clarity, in reality, delineating various components is not so clear, and metaphorically, the lines would more accurately be grey and fuzzy. For example, one may consider a presentation component such as a display device to be one of I/O components 620. Also, processors, such as one or more processors 614, have memory. The present disclosure hereof recognizes that such is the nature of the art, and reiterates that FIG. 6 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 612 may take the form of memory components described herein. Thus, further elaboration will not be provided here, but it should be noted that memory 612 may include any type of tangible medium that is capable of storing information, such as a database. A database may be any collection of records, data, and/or information. In one embodiment, memory 612 may include a set of embodied computer-executable instructions that, when executed, facilitate various functions or elements disclosed herein. These embodied instructions will variously be referred to as “instructions” or an “application” for short.

Processor 614 may actually be multiple processors that receive instructions and process them accordingly. Presentation component 616 may include a display, a speaker, and/or other components that may present information (e.g., a display, a screen, a lamp (LED), a graphical user interface (GUI), and/or even lighted keyboards) through visual, auditory, and/or other tactile cues.

Radio 624 represents a radio that facilitates communication with a wireless telecommunications network. Illustrative wireless telecommunications technologies include CDMA, GPRS, TDMA, GSM, and the like. Radio 624 might additionally or alternatively facilitate other types of wireless communications including Wi-Fi, WiMAX, LTE, 3G, 4G, LTE, mMIMO/5G, NR, VOLTE, or other VoIP communications. As can be appreciated, in various embodiments, radio 624 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

The input/output (I/O) ports 618 may take a variety of forms. Exemplary I/O ports may include a USB jack, a stereo jack, an infrared port, a firewire port, other proprietary communications ports, and the like. Input/output (I/O) components 620 may comprise keyboards, microphones, speakers, touchscreens, and/or any other item usable to directly or indirectly input data into the computing device 600.

Power supply 622 may include batteries, fuel cells, and/or any other component that may act as a power source to supply power to the computing device 600 or to other network components, including through one or more electrical connections or couplings. Power supply 622 may be configured to selectively supply power to different components independently and/or concurrently.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

What is claimed is:

1. A system for data channel switching, the system comprising:
one or more processors; and
one or more computer-readable media storing computer-usable instructions that, when executed by the one or more processors, cause the one or more processors to:
connect a device to a first data channel via a first subscriber identity module (SIM) profile, wherein the first SIM profile enables push-to-talk (PTT) capabilities;
identify that the first data channel has failed;
communicate a request to re-authenticate with a second data channel utilizing a second SIM profile;
attach to the second data channel utilizing the second SIM profile; and
activate PTT capabilities utilizing the first SIM profile on the second data channel associated with the second SIM profile.

2. The system of claim 1, wherein the first data channel is associated with a first carrier and the second data channel is associated with a second carrier.

3. The system of claim 1, wherein the first carrier is different from the second carrier.

4. The system of claim 1, wherein the device is a dual-SIM device.

5. The system of claim 1, wherein the one or more processors is further configured to identify that the first data channel is available.

6. The system of claim 5, wherein the first data channel is determined to be available using periodic health checks of the first data channel.

7. The system of claim 5, wherein the one or more processors is further configured to re-attach the device to the first data channel utilizing the first SIM profile.

8. A method for data channel switching, the method comprising:
connecting a device to a first data channel via a first subscriber identity module (SIM) profile, wherein the first SIM profile enables push-to-talk (PTT) capabilities;
identifying that the first data channel has failed;
communicating a request to re-authenticate with a second data channel utilizing a second SIM profile;
attaching to the second data channel utilizing the second SIM profile; and
activating PTT capabilities utilizing the first SIM profile on the second data channel associated with the second SIM profile.

9. The method of claim 8, wherein the first data channel is associated with a first carrier and the second data channel is associated with a second carrier.

10. The method of claim 9, wherein the first carrier is different from the second carrier.

11. The method of claim 8, wherein the device is a dual-SIM device.

12. The method of claim 8, further comprising identifying that the first data channel is available.

13. The method of claim 12, further comprising re-attaching the device to the first data channel utilizing the first SIM profile.

14. The method of claim 12, wherein the first data channel is determined to be available using periodic health checks of the first data channel.

15. The method of claim 8, wherein the first SIM profile and the second SIM profile are associated with either an electronic SIM or a physical SIM.

16. The method of claim 8, further comprising launching a PTT application utilizing the first SIM profile while on the second data channel associated with the second SIM profile.

17. A method for data channel switching, the method comprising:
connecting a device to a first data channel via a first subscriber identity module (SIM) profile, wherein the first SIM profile enables push-to-talk (PTT) capabilities;
identifying that the first data channel has failed;
communicating a request to re-authenticate with a second data channel utilizing a second SIM profile;
attaching to the second data channel utilizing the second SIM profile to establish a second data channel data connection;
activating PTT capabilities utilizing the first SIM profile on the second data channel associated with the second SIM profile;
identifying that the first data channel is available; and
switching from the second data channel to the first data channel, wherein a first data channel data connection and PTT capabilities are enabled utilizing the first SIM profile.

18. The method of claim 17, wherein the first data channel is associated with a first carrier and the second data channel is associated with a second carrier.

19. The method of claim 18, wherein the first carrier is different than the second carrier.

20. The method of claim 18, further comprising terminating the attachment to the second data channel via the second SIM profile once the device has re-connected to the first data channel.
